(19) United States
(12) Patent Application Publication
(10) Pub. No.: US 2015/0258739 A1
(43) Pub. Date: Sep. 17, 2015

(54) MOLD FOR STAMPING AND OVERMOLDING INSERTS MADE OF COMPOSITE MATERIAL AND ASSOCIATED OVERMOLDED PART MANUFACTURING METHOD

(71) Applicant: VALEO SYSTEMES THERMIQUES, Le Mesnil Saint Denis (FR)

(72) Inventors: Issmail Meskin, Le Mesnil Saint-Denis (FR); Sébastien Velasco, Gyancourt (FR)

(73) Assignee: VALEO SYSTEMES THERMIQUES, Le Mesnil Saint Denis (FR)

(21) Appl. No.: 14/437,272

(22) PCT Filed: Oct. 22, 2013
(86) PCT No.: PCT/EP2013/072033

§ 371 Date: Apr. 21, 2015

(30) Foreign Application Priority Data
Oct. 26, 2012 (FR) 1260265

(51) Int. Cl. B29C 69/00; B29C 45/14

(52) U.S. Cl. CPC B29C 69/001; B29C 45/14; B29C 2045/1486; B29K 2101/12

(57) ABSTRACT

A mold for stamping and overmolding inserts made of composite material is disclosed. The mold includes a first and a second half-mold complementing one another and defining a space for reception and overmolding of the insert made of composite material. The first half-mold has at least one orifice inside which is placed a hole punch-forming blade borne by the end of a mobile support, to be able to cut the insert made of composite material, where the blade is also contiguous with the wall of the orifice. The second half-mold has an orifice facing the at least one orifice of the first half-mold, inside which is placed a plunger of corresponding form and contiguous with the wall of the orifice and mobile to be able to come into contiguous contact with the blade.

The present invention relates to a mold for overmolding inserts made of composite material, and more particularly a mold for overmolding and stamping. The invention relates also to a method for manufacturing an overmolded part using the abovementioned mold.

Increasingly, notably in the field of automobile construction, particular attention is being paid to reducing the weight of the various parts while guaranteeing equivalent or even higher mechanical performance levels.

One known solution for addressing these constraints imposed by the specifications of the various constructors is to propose overmolded parts made of composite material. These parts are generally manufactured from a sheet of composite material which is initially shaped, for example by stamping in a first mold, to form an insert made of composite material. Secondly, the inserts made of composite material are machined, for example by means of specific machine tools to then be placed in molds for overmolding.

This manufacturing method thus requires the use of different molds and machine tools which lengthen the manufacturing time and which have a cost on top of the production cost of the final overmolded part made of composite material.

One of the aims of the invention is therefore to at least partially address the drawbacks of the prior art and propose a mold and a manufacturing method that are improved and cost effective.

The present invention therefore relates to a mold for stamping and overmolding inserts made of composite material, said mold comprising a first and a second half-mold complementing one another and defining a space for reception and overmolding of the insert made of composite material, and at least one orifice for injecting overmolding material:
the first half-mold comprising at least one orifice inside which is placed a hole punch-forming blade borne by the end of a mobile support, so as to be able to cut the insert made of composite material, said blade being also contiguous with the wall of the orifice of the first half-mold,
the second half-mold comprises an orifice, facing the at least one orifice of the first half-mold, inside which is placed a plunger of corresponding form and contiguous with the wall of the orifice of the second half-mold and mobile so as to be able to come into contiguous contact with the blade.

The mold thus makes it possible to stamp the insert made of composite material, cut the latter according to a desired machining by virtue of the blade and overmold the insert made of composite material through the contiguous nature of the contacts between the various elements. These three operations can thus be carried out from one and the same mold so as to form a cost-effective final overmolded part.

According to one aspect of the invention, facing the blade, the second half-mold comprises a cutting plate.

According to another aspect of the invention, the cutting plate is made of very hard steel.

According to another aspect of the invention, the blade is an attached and removable element fixed onto the support.

According to another aspect of the invention, the support comprises a discharge channel and that the plunger comprises at least one protuberance so as to push the cutting scrap from the insert made of composite material inside said discharge channel.

According to another aspect of the invention, the orifices, the support, the plunger and the blade have a circular form.

The present invention also relates to a method for manufacturing an overmolded part, comprising an insert made of composite material, by means of a mold according to one of the preceding aspects and comprising the following steps:
a step of placement of a composite material between the first and the second half-mold,
a step of closure of the mold and of stamping by bringing the two half-molds together,
a step of thrusting of the support of the at least one orifice toward the reception and overmolding space so as to cut the insert made of composite material by means of the blade,
a step of thrusting of the plunger so that it enters into tight contact with the blade and pushes back said blade and the support so as to tightly enclose the reception and overmolding space,
a step of injection of the overmolding material, and
a step of opening of the mold by separation of the two half-molds and of discharging of the overmolded part.

According to one aspect of the manufacturing method, the support comprises a discharge channel and the plunger comprises at least one protuberance so as to push the cutting scrap from the insert made of composite material inside said discharge channel.

According to another aspect of the manufacturing method, between the step of thrusting of the at least one support toward the reception and overmolding space and the step of injection of the overmolding material, said method comprises an additional step of spacing apart of the two half-molds in order to enlarge the reception and overmolding space to accommodate a predetermined volume of overmolding material.

Other features and advantages of the invention will become more clearly apparent on reading the following description, given as an illustrative and nonlimiting example, and the attached drawings in which:

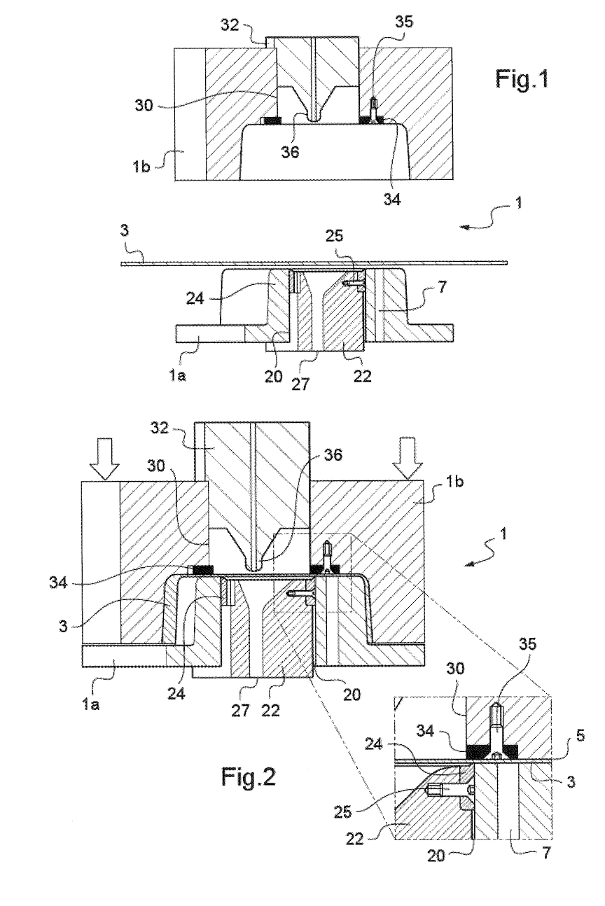

FIGS. 1 to 5 show perspective representations in cross section of a mold according to the invention, during different moments of the manufacturing method,

FIGS. 6 and 7 show flow diagrams showing the steps of the manufacturing method according to two embodiments.

Identical elements in the different figures bear the same references.

FIGS. 1 to 5 show perspective representations in cross section of a mold 1 according to the invention, at different moments of the manufacturing method 100.

The mold 1 for stamping and overmolding inserts made of composite material 3 comprises a first and a second half-mold 1a, 1b complementing one another and defining a space for reception and overmolding 5 of the insert made of composite material 3. The form of the first and second half-molds 1a, 1b makes it possible to shape said insert made of composite material 3 by stamping. The mold 1 also comprises an orifice 7 for injecting overmolding material 9 through which the overmolding material 9, for example a thermoplastic, is injected into the reception and overmolding space 5.

As shown in FIGS. 1 to 5, the first half-mold 1a comprises at least one orifice 20 inside which is placed a hole punch-forming blade 24 borne by the end of a mobile support 22 so as to be able to cut the insert made of composite material 3 by movement of the support 22 toward the reception and overmolding space 5. The blade 24 is contiguous with the wall of the orifice 20 of the first half-mold 1a. The blade 24 can be made of a single piece with the support 22 or else, as represented in FIGS. 1 to 5, be an attached and removable element fixed onto the support 22, for example by means of screws 25.

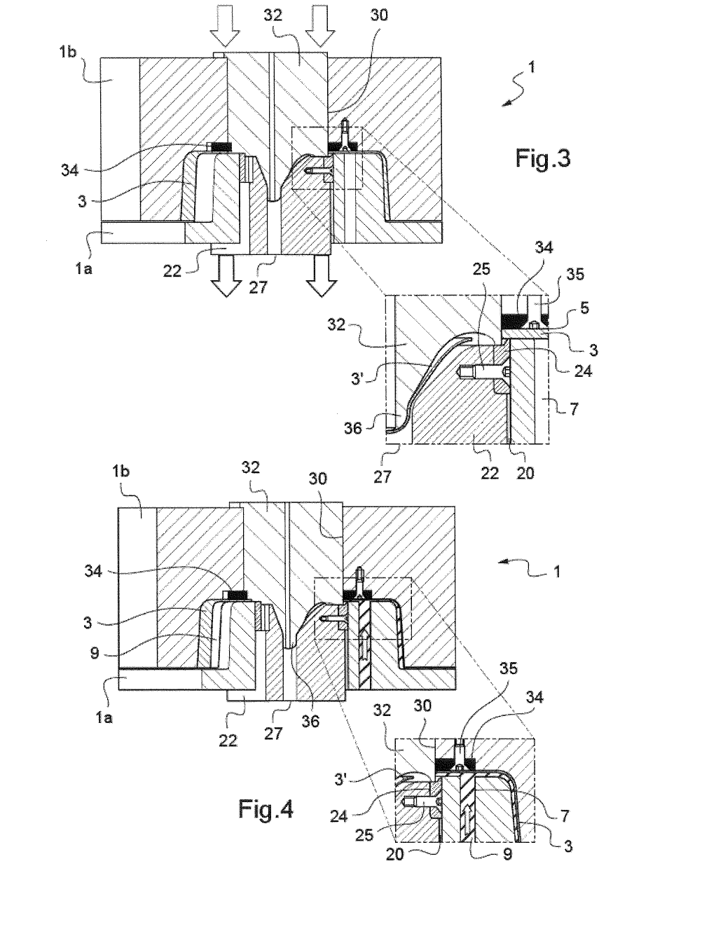

The second half-mold 1b comprises an orifice 30, facing the at least one orifice 20 of the first half-mold 1a, inside which is placed a plunger 32 of corresponding form and contiguous with the wall of the orifice 30 of the second half-mold 1b. The plunger is mobile inside the orifice 30 of the second half-mold 1b so as to be able to come into contiguous contact with the blade 24. For this, the orifice 30 of the second half-mold 1b is of a size smaller than the orifice 20 of the first half-mold 1a, such that the end of the plunger 32 can enter into contact with the blade 24 as to show in FIGS. 3 and 4.

The second half-mold 1b can also comprise a cutting plate 34, facing the blade 24 so as to facilitate the cutting of the insert made of composite material 3 and protect the second half-mold 1b from said blade. The cutting plate 34 can be made of very hard steel and be fixed to the second half-mold 1b by means of screws 35.

According to a particular embodiment, the support 22 can comprise a discharge channel 27 at its center in order to accommodate and allow the discharging of the cutting scrap 3′ from the insert made of composite material 3. For its part, the plunger 32 of the second half-mold 1b can comprise at least one protuberance 36 so as to push back the cutting scrap 3′ into the discharge channel 27 of the plunger 22.

The fact that the plunger 32 is contiguous with the wall of the orifice 30 and also that it can come into contiguous contact with the blade 24 (itself contiguous with the orifice 20) makes it possible to tightly enclose the reception and overmolding space 5. The reception and overmolding space 5 can thus accommodate an injection of overmolding material 9 via the injection orifice 7 which will fill it and will overmold the insert made of composite material 3.

By varying the number of orifices 20, 30, it is thus possible to directly machine the insert made of composite material 3 inside the mold 1. The form of the cut made by the hole punch-forming blade 34, and the form of the plunger 32, of the support 22 and of the orifices 20, 30, can for example be circular in order to form a tubular orifice for the passage of an axis or of a fixing screw into the overmolded part 3, 9 after overmolding.

Because of this, the mold 1 makes it possible to stamp the insert made of composite material 3, cut the latter according to a desired machining and overmold the insert made of composite material 3 so as to form a final overmolded part 3, 9 that is cost effective because it requires fewer operations and machine tools for its manufacture.

The present invention relates also to a method for manufacturing 100 an overmolded part 3, 9 comprising an insert made of composite material 3, by means of a mold 1 as described previously. FIGS. 6 and 7 show a flow diagram of the different steps of such a manufacturing method 100 according to two embodiments.

The manufacturing method thus comprises a step 102 of placement of a composite material 3 in the mold 1, for example in the form of a sheet, and more specifically between the two half-molds 1a, 1b. This step is notably illustrated by FIG. 1.

This step 102 is followed by a step 104 of closure of the mold 1 and of stamping by bringing the two half-molds 1a, 1b together.

Then comes a step 106 of thrusting of the support 22 in the at least one orifice 20 of the first half-mold 1a toward the reception and overmolding space 5. The aim of this step 106 is to cut the insert made of composite material 3 by means of the blade 24 within the reception and overmolding space 5.

The steps 104 and 106 are particularly illustrated by FIG. 2.

The step 106 is followed by a step 108 of thrusting of the plunger 32 so that it enters into tight contact with the blade 24 and pushes back the blade 24 and the support 22 so as to tightly enclose the reception and overmolding space 5. This step 106 is particularly illustrated by FIG. 3.

In the particular embodiment where the support 22 comprises a discharge channel 27 and where the plunger has at least one protuberance 36, this step 108 also makes it possible to discharge the cutting scrap 3′. The latter is pushed back by the at least one protuberance 36 in the discharge channel 27.

Then a step 110 is carried out of injection of the overmolding material 9 into the reception and overmolding space 5 by means of the injection orifice 7. This step 110 is particularly illustrated by FIG. 4.

Between the step 106 of thrusting of the support 22 toward the reception and overmolding space 5 and the step 110 of injection of the overmolding material 9, said method can comprise an additional step 114 of spacing apart of the two half-molds 1a, 1b in order to enlarge the reception and overmolding space 5 to accommodate a predetermined volume of overmolding material 9.

FIG. 6 shows a first embodiment where the additional step 114 is performed following the step 106 of thrusting of the support 22 toward the reception and overmolding space 5.

For its part, FIG. 7 shows a second embodiment where the additional step 114 is carried out following the step 108 of thrusting of the plunger 32.

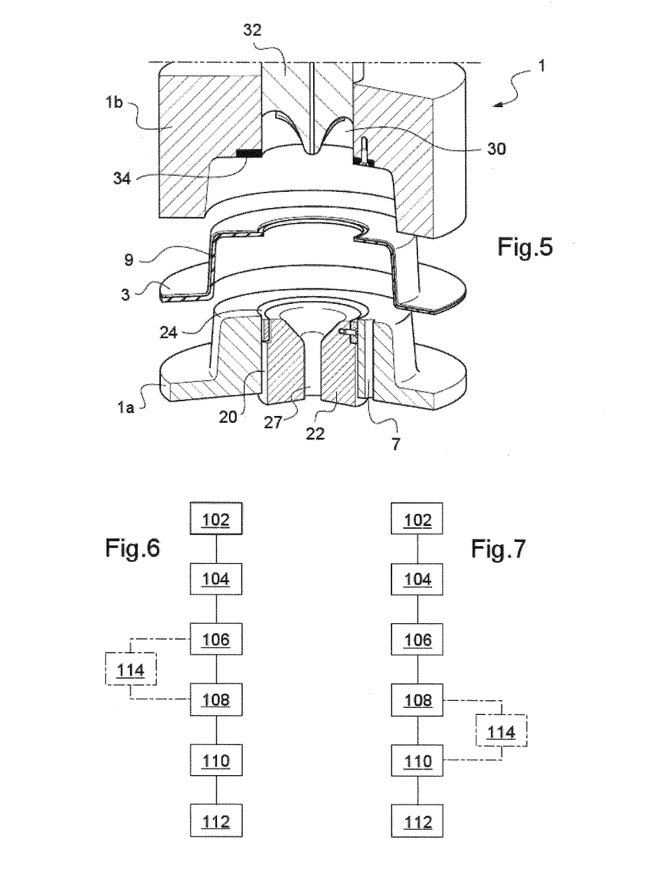

Finally, a step 112 is carried out of opening of the mold 1 by separation of the two half-molds 1a, 1b and discharging of the overmolded part 3, 9. This step 112 is particularly illustrated by FIG. 5.

Thus it can clearly be seen that the mold 1 allows three operations which are the stamping of the insert made of composite material 3, the cutting of the latter according to a desired machining and the overmolding of the insert made of composite material 3. This thus makes it possible to obtain, after the manufacturing method 100, an overmolded part 3, 9 that is cost effective because it requires fewer operations and machine tools for its manufacture.

1. A mold for stamping and overmolding inserts made of composite material, said mold comprising:
a first and a second half-mold complementing one another and defining a space for reception and overmolding of the insert made of composite material wherein:
the first half-mold comprises at least one orifice inside which is placed a hole punch-forming blade borne by the end of a mobile support, the hole punch-forming balde being able to cut the insert made of composite material and being also contiguous with the wall of the orifice of the first half-mold, and
the second half-mold comprises an orifice, facing the at least one orifice of the first half-mold, inside which is placed a plunger of corresponding form and contiguous with the wall of the orifice of the second half-mold and mobile so as to be able to come into contiguous contact with the blade.

2. The mold as claimed in claim 1, wherein, facing the blade, the second half-mold comprises a cutting plate.

3. The mold as claimed in the preceding claim 2, wherein the cutting plate is made of very hard steel.

4. The mold as claimed in claim 1, wherein the blade is an attached and removable element fixed onto the support.

5. The mold as claimed in claim 1, wherein the support comprises a discharge channel and wherein the plunger comprises at least one protuberance so as to push the cutting scrap from the insert made of composite material inside said discharge channel.

6. The mold as claimed in claim 1, wherein the orifices, the support, the plunger and the blade have a circular form.

7. A method for manufacturing an overmolded part, comprising an insert made of composite material, the overmolded part being manufactured using a mold as claimed in claim 1, the method comprising:
a step of placement of a composite material between the first and the second half-mold;
a step of closure of the mold and of stamping by bringing the two half-molds together;
a step of thrusting of the support of the at least one orifice toward the reception and overmolding space so as to cut the insert made of composite material by means of the blade;
a step of thrusting of the plunger resulting in the plunger entering into tight contact with the blade and pushing back said blade and the support so as to tightly enclose the reception and overmolding space;
a step of injection of the overmolding material; and
a step of opening of the mold by separation of the two half-molds and of discharging of the overmolded part.

8. The manufacturing method as claimed in claim 7, wherein the support comprises a discharge channel and wherein the plunger comprises at least one protuberance so as to push the cutting scrap from the insert made of composite material inside said discharge channel.

9. The manufacturing method as claimed in claim 8, wherein, between the step of thrusting of the at least one support toward the reception and overmolding space and the step of injection of the overmolding material, said method further comprises an additional step of spacing apart of the two half-molds to enlarge the reception and overmolding space to accommodate a predetermined volume of overmolding material.
